(19) United States
(12) Patent Application Publication
(10) Pub. No.: US 2007/0097101 A1
(43) Pub. Date: May 3, 2007

(54) User-interface system, method & apparatus

(75) Inventors: Andrew Arthur Hunter, Bristol (GB); Kenton O'Hara, Bristol (GB); Robert Thomas Owen Rees, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/492,115

(22) Filed: Jul. 25, 2006

(30) Foreign Application Priority Data
Oct. 29, 2005 (GB) 0522124.7

(51) Int. Cl. G09G 5/00

(52) U.S. Cl. 345/179

(57) ABSTRACT

A user-interface system for interfacing with a device, the system comprising a printed user-manual for the device, wherein a user is able to interface with the device by using a digital pen to mark a portion of the user-manual or otherwise indicate a desired configuration setting for the device using the pen and the manual, and method.

The present invention relates to the Applicant's concurrently filed U.S. patent application HP Docket No. 200503448-2 entitled “MARKING MATERIAL,” the content of which is entirely incorporated herein by reference.

### CLAIM TO PRIORITY

This application claims priority from co-pending United Kingdom utility application entitled, “User-Interface System, Method & Apparatus” having serial no. GB 0522124.7, filed Oct. 29, 2005, which is entirely incorporated herein by reference.

### FIELD OF THE INVENTION

The present invention relates generally to a user-interface, and more specifically, but not exclusively, to a user-interface system suitable for use with a digital pen and paper system.

### BACKGROUND

When configuring or learning to use a product (or service) it is common to read instructions from an instruction manual. It is then generally necessary to carry out instructions on a real interface by pressing buttons on a device, or by interacting indirectly via a telephone keypad for example. Often, it is difficult to operate the real interface whilst holding and reading an instruction manual. Furthermore, it is often important to record information that has been used to configure a product or service, but there is generally no way to ensure that the information gets recorded.

Systems have been proposed which avoid this problem by including the equivalent of an instruction manual within the interface of the system. For example, web-based systems can use the page-like format of a web page to describe the system and the necessary configuration actions, and can also record configuration data entered on the page by the user of the system. Unfortunately this can make the system more complex than it would otherwise need to be, and may only work with systems having displays.

Paper-based instruction manuals sometimes invite users to write configuration data in specific sections of the manual so that they can refer to the data at a later date. If this is used properly, it preserves a record of the configuration but there is no way to ensure that the data is written into the manual or that it is entered accurately. It does nothing to avoid the awkwardness of operating the real user interface while reading (and writing) in the instruction manual.

### SUMMARY

According to a first aspect of the present invention there is provided a user-interface system for interfacing with a device, the system comprising a printed user-manual for the device, wherein a user is able to interface with the device by using a digital pen to mark a portion of the user-manual or otherwise indicate a desired configuration setting for the device using the pen and the manual.

According to a second aspect of the present invention there is provided a method for configuring a product using a printed user-manual for the product, the method comprising using a digital pen to mark at least a portion of the user-manual or otherwise indicate, using the manual, a desired configuration setting for the product, generating position data representing the position of the pen with respect to the user-manual where the mark or indication was made, using the position data to determine an instruction or configuration setting for the product, and executing the instruction or setting.

### BRIEF DESCRIPTION OF THE FIGURES

For a better understanding of the present invention, and to further highlight the ways in which it may be brought into effect, embodiments will now be described, by way of example only, with reference to the following drawings in which:—

FIG. 1 is a schematic representation of a carrier comprising a data encoding pattern and content;

FIG. 2 is schematic representation of a portion of an exemplary data encoding pattern;

FIG. 3 is a schematic representation of a detector for use with the product of FIG. 1;

FIG. 4 is a schematic representation of a portion of a user-manual;

FIG. 5 is a schematic representation of a user-interface system according to an embodiment; and

FIG. 6 is a flow chart representing a method according to an embodiment.

It should be emphasised that the term “comprises/comprising” when used in this specification specifies the presence of stated features, integers, steps or components but does not preclude the presence or addition of one or more other features, integers, steps, components or groups thereof.

### DETAILED DESCRIPTION OF PREFERRED EMBODIMENTS

According to an embodiment, a user reading an instruction manual for a product (or service) can use a device, such as a digital pen, to operate representations of controls of the product, and can record data and/or configurations by using the device to write and/or draw onto the manual. The manual can be used as a user-interface for performing actions in connection with the product or service.

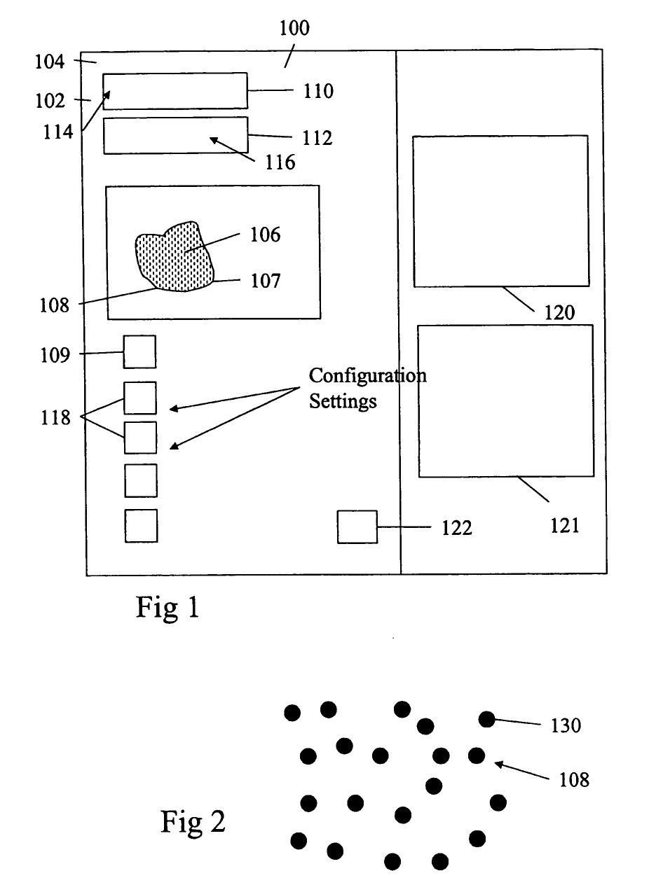

Referring to FIG. 1, a document 100 for use in a digital pen and paper system comprises a carrier 102 in the form of a single sheet of paper 104 with position identifying markings 106 printed on some parts of it to form areas 107 of a position identifying pattern 108. Also printed on the paper 104 are further markings 109 which are clearly visible to a human user of the form, and which make up content of the document 100. The content 109 depends on the intended use of the document. The content, format or use of the document described with reference to FIG. 1 is not intended to be limiting. In this case an example of a simple instruction manual for a product (not shown) is depicted. The content comprises a number of boxes 110, 112 which can be used for recording data and/or configuration settings of the product for example. The content further comprises a number of check boxes 118 any one of which can be marked by a user, and two larger boxes 120, 121 in which the user can write comments, data and/or product configuration settings, and/or draw figures, as well as some printed text and images which can relate to the instructions for using the product. The instructions etc are shown in schematic form for the sake of simplicity, however it will be appreciated that any level of complexity of instructions and/or diagrams for the product or service in question can be used. The manual can comprise a box 122 which can be checked by the user when they have completed setting up/configuring the product or service. For example, when ticked or marked, this can initiate a completion process by which stroke data from the device used to mark the manual and typographical information on the manual is forwarded, or transmitted, for processing for example. Other alternatives are possible.

A position identifying pattern 108 can be printed onto the parts of the manual which the user is expected to write on or mark, such as within check boxes and/or comments boxes and the send box 122 for example, or over an entire page of the manual.

Referring to FIG. 2, an exemplary position identifying pattern 108 is made up of a number of markings 130. The arrangement of the markings defines an imaginary pattern space, and only a small part of the pattern space need be taken up by the pattern on the document 100. By allocating a known area of the pattern space to the document 100, for example by means of a co-ordinate reference, the document and any position on the patterned parts of it can be identified from the pattern printed on it. It will be appreciated that many position identifying patterns can be used. Some examples of suitable patterns are described in WO 00/73983, WO 01/26033 and WO 01/71643 for example.

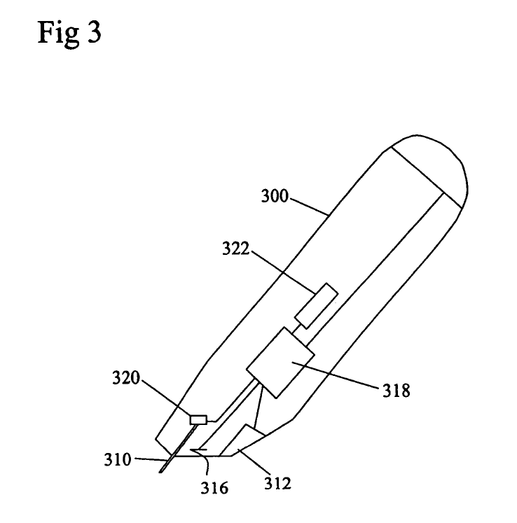

Referring to FIG. 3, a detector in the form of a digital pen suitable for use with the pattern as described above is schematically depicted. Digital pen 300 comprises a writing stylus 310, and a camera 312. The camera 312 is arranged to image an area adjacent to the tip 311 of the pen stylus 310. A processor 318 processes images from the camera 312. A pressure sensor 320 detects when the stylus 310 is in contact with the document 100 and triggers operation of the camera 312. Whenever the pen is being used on a patterned area of the document 100, the processor 318 can therefore determine from the pattern 108 the position of the stylus of the pen whenever it is in contact with the document 100. From this it can determine the position and shape of any marks made on the patterned areas of the document 100. This information can be stored in a memory 322 in the pen as it is being used. The pen can be provided with an output port which can comprise at least one electrical contact that connects to corresponding contacts on a base station (not shown). Alternatively, the pen and base station can communicate wirelessly using an infra-red or radio frequency communications link such as Wi-Fi or Bluetooth for example. Other alternatives are possible.

Although reference is made herein to a digital pen (and paper system) comprising a camera this is not intended to be limiting. Particularly, the use of a data encoding pattern is not necessary. Such a device can be incorporated into a number of products, not just a pen. For example, an image capture device can be incorporated into a mobile station such as a mobile telephone or pager, or in a personal digital assistant where some form of functionality for marking the paper is included. For example, a stylus of a PDA can be used if it has the ability to sense which medium it is being used on and adjust a writing/pointing tip/nib appropriately.

According to an embodiment, an instruction manual for a product can be a conventional printed paper manual (and so is very cheap and can be printed in numerous versions for different languages, levels of skill, etc.). The manual can be a printed manual which comes with a product, or can be one which is retrieved from a network such as the internet for example, and printed by a user. The pages of the manual that offer interactive functions can comprise a pattern such as 108 described above. Alternatively, other position identifying methods for the device can be used. For example, the pen can comprise a GPS-type unit which is adapted to generate data representing changes in the position of the pen. This data can be used to determine a relative position of the pen with respect to the product. Alternatively, if knowledge of content, for example, printed on the product surface is known, this can be compared with an image of a portion of the product surface generated using an image capture device of the pen. The comparison can be used to determine the pen position relative to the product surface. Other alternatives are possible. For example, a product can comprise pieces of material, such as metal for example. The pen can sense its position by triangulating its position using the pieces of material. For example, the pieces of metal, or other material, can be adapted to have different properties, and the pen can use this fact to determine its position relative to the pieces and hence the product. So, for example, the pen can hold a digital map of the printed content on all the pages of a document. The pen can be pre-programmed with the appearance of the document for example. A camera in the pen then detects any printed content close to the position of the pen tip and searches the stored content to work out exactly where the pen must be (allowing for perspective distortions). Such a pen could not detect absolute position on a blank page (because there would be no content to reference the position from) but could construct relative pen motions (after beginning to write) by imaging the ink from the pen strokes or by using paper fibre sensing technology. Alternatively, a blank page could have content that is printed in invisible IR ink that can be imaged by the camera, but by avoiding the need for invisible ink markings, the document pages could be printed by the user on any available inkjet or laser jet printer, and a mechanism can be provided for loading the appearance of the pages into a digital pen. The pages of the document can be printed to ensure there are always enough visible points of reference. Text boxes, tick boxes, and representations of controls can all be printed to ensure that visually distinct images will be sensed by the camera in the pen to allow it to identify the exact page and position within the page.

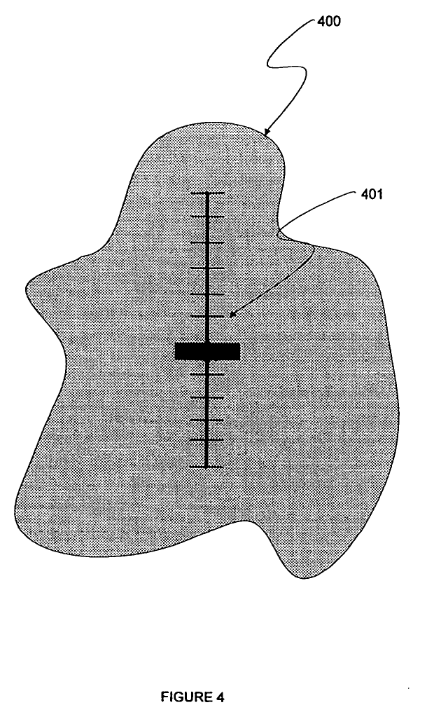

Advantageously, according to an embodiment, pen 300 can issue wireless commands directly to the product in question (or indirectly via another device or network such as the internet for example). Pen 300 includes a conventional source of ink for marking the manual. As the user writes in the manual, the writing can be recognised and sent as configuration commands to the system thus ensuring that a record is made and avoiding direct operation of a physical interface while reading the manual. Hence the pen is used to mark a portion of the user-manual or otherwise indicate a desired configuration setting for the device using the pen and the manual. For example, a schematic representation of a volume control can be printed on the manual, and the pen can be used to adjust a volume of the device, in substantially real-time for example, by moving the pen over the printed volume control as if to adjust the level. In this case, no mark need be left by the pen since its function is to adjust a configuration setting of the device, and marks could interfere with the future adjustment of this setting. Other configuration settings of a device can be adjusted in this manner as will be appreciated, and the above is not intended to be limiting. FIG. 4 is a schematic representation of such a portion 400 of a user-manual which has a printed volume control 401 which can be adjusted by a user with a pen as described. The portion 400 also schematically (and in an exaggerated fashion) a data encoding pattern comprising a plurality of dots on the portion. Such an augmented instruction manual allows parametric data to be entered by writing (e.g. to enter a start time or to set initial configurations) or by drawing (e.g. to draw links between illustrated components) for example. In many cases, handwriting and drawing may be a more efficient means for entering configuration data than via a conventional physical interface.

Furthermore, some devices that require configuration may be too small or may be too remote to support a convenient user interface. Similarly, a device may be accessible but difficult to configure whilst reading the manual (e.g. while reading the instruction book for a VCR from the comfort of a sofa). In other cases, the instruction manual may offer an interface to a service or software product that has no physical existence and hence cannot have its own conventional user interface. A printed manual can be easily tailored for different circumstances. It can provide separate instructions and controls tailored for different languages, skills levels, quick setup or in-depth setup, etc. As described, manuals can also be downloaded from a network such as the internet, and printed by users, or may be offered by third parties or as “how to” books detailing how to operate a particular device or piece of software for example. Thus the instructions and controls can be tailored at the point of use rather than during product manufacturing or during distribution in different countries. The instructions can also be reprinted easily to provide new controls if new device firmware is provided after initial purchase.

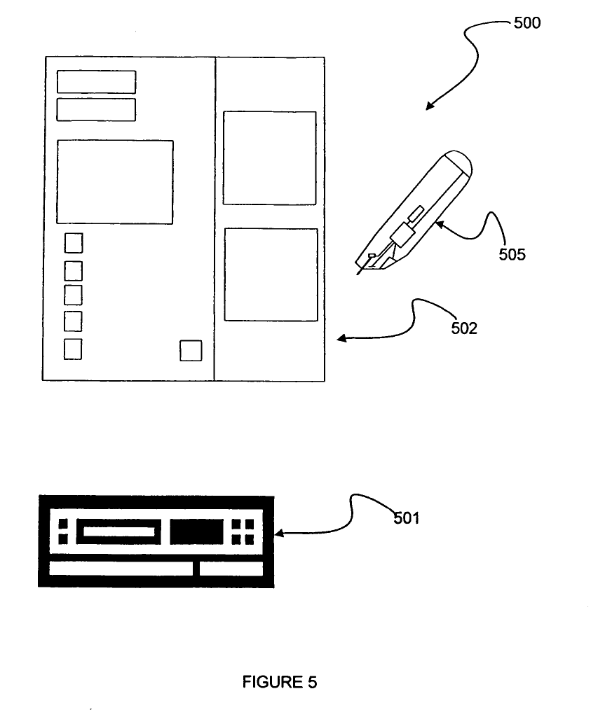

FIG. 5 is a schematic representation of a user-interface system according to an embodiment. A user-interface system 500 for interfacing with a device 501 comprises a printed user-manual 502 for the device 501. A user is able to interface with the device 501 by using a digital pen 505 to mark a portion of the user-manual 502 or otherwise indicate a desired configuration setting for the device 501 using the pen 505 and the manual 502.

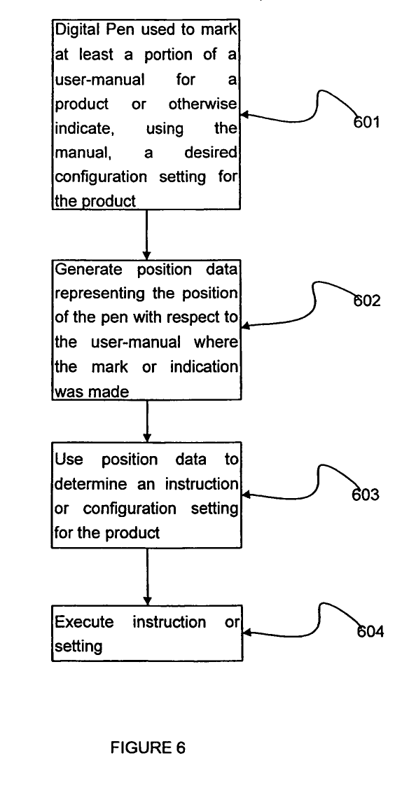

FIG. 6 is a flow chart representing a method according to an embodiment. At step 601 a digital pen is used to mark at least a portion of a user-manual, or otherwise indicate, using the manual, a desired configuration setting for a product. At 602 position data representing the position of the pen with respect to the user-manual where the mark or indication was made is generated. At 603 the position data is used to determine an instruction or configuration setting for the product, and the instruction or setting is executed at 604.

1. A user-interface system for interfacing with a device, the system comprising a printed user-manual for the device, wherein a user is able to interface with the device by using a digital pen to mark a portion of the user-manual or otherwise indicate a desired configuration setting for the device using the pen and the manual.

2. A user-interface system as claimed in claim 1, wherein interfacing with the device comprises marking the manual, or otherwise indicating a desired configuration setting using the manual, on a predetermined manual portion in order to provide the desired configuration setting for the device.

3. A user-interface system as claimed in claim 1, further comprising:
generating position data representing the position of the pen when a mark or indication was made on the user-manual, and using the position data in order to determine at least one of a command, configuration setting and instruction for the device.

4. A user-interface system as claimed in claim 3, wherein determining the at least one of a command, configuration setting and instruction for the device comprises:
using the position data to determine a portion of the manual which has been marked or used to indicate a desired configuration setting;
using the position data to determine a character for the indication or which has been marked on the portion; and
on the basis of the determinations, generating configuration data representing a desired command, configuration setting and instruction for the device.

5. A user-interface system as claimed in claim 3, wherein data representing the position of the detector is determined using a data encoding pattern printed on at least a portion of the user-manual.

6. A user-interface system as claimed in claim 4, wherein the detector is operable to wirelessly communicate the configuration data to the device.

7. A method for configuring a product using a printed user-manual for the product, the method comprising:
using a digital pen to mark at least a portion of the user-manual, or otherwise indicate, on the manual using the pen, a desired configuration setting for the product;
generating position data representing the position of the pen with respect to the user-manual where the mark or indication was made;
using the position data to determine an instruction or configuration setting for the product; and
executing the instruction or setting.

8. A method as claimed in claim 7, wherein marking the user-manual comprises:
determining a desired configuration for a product feature;
on the basis of the determination, selecting a portion of the user-manual corresponding to the desired configuration; and
marking, or providing an indication on, the selected portion in a predetermined way in order to invocate the configuration.

9. A method as claimed in claim 8, wherein the predetermined way comprises at least one of writing, annotating, and drawing.

10. A method as claimed in claim 7, wherein indicating a desired configuration setting for the product comprises selecting a desired setting using the manual from a group of possible settings.

11. A printed user-manual for use with a system as claimed in claim 1.

12. An apparatus in which a printed user-manual functions as an interface with a device and which comprises:
a printed user-manual for the device, wherein a user is able to interface with the device by using a digital pen to mark a portion of the user-manual or otherwise indicate a desired configuration setting for the device using the pen and the manual.
